(19) United States
(12) Patent Application Publication
(10) Pub. No.: US 2009/0142559 A1
(43) Pub. Date: Jun. 4, 2009

(54) METHOD OF FORMING CONDUCTIVE TRACKS FOR FLEXIBLE ELECTRONIC CIRCUITS

(76) Inventors: Peter Hewitson, Middlesex (GB); Sean D. Slater, Cambridgeshire (GB); John R. Fyson, London (GB); Christopher B. Rider, Cambridgeshire (GB)

Correspondence Address: EASTMAN KODAK COMPANY;PATENT LEGAL STAFF, 343 STATE STREET, ROCHESTER, NY, 14650-2201, US

(21) Appl. No.: 12/066,394

(22) PCT Filed: Sep. 7, 2006
(86) PCT No.: PCT/GB06/03294

§ 371 Date: Jul. 18, 2008

(30) Foreign Application Priority Data
Sep. 13, 2005 (GB) 0518607.7

(51) Int. Cl. B32B 5/00; B28B 11/08

(52) U.S. Cl. 428/209; 264/293

(57) ABSTRACT

Conductive tracks are formed on a support by providing a coated support where the coating is susceptible to forming a latent image upon pressure-exposure (e.g. a coating of a silver halide emulsion in gelatin), pressure exposing said coated support according to a desired track pattern to form a latent image of the track pattern and developing the latent image to form a conductive metal track pattern corresponding to the latent image. The latent image may be formed, for example, by applying pressure using a stylus or scalpel, an engraved stamp or a roller carrying a relief pattern. The method is capable of forming conductive tracks at very high resolution (e.g. 10 μm or less), optionally on a flexible support.

### FIELD OF THE INVENTION

The present invention relates to the formation of conductive materials as conductive tracks for use in electronic circuit boards and devices utilising such conductive tracks. The invention is particularly concerned with the formation of conductive tracks for electronic circuits of high resolution (i.e. fine tracks) on a flexible support in a simple and effective manner without the need for complex optical exposure associated with the preparation of, for example, printed circuit boards by conventional means.

### BACKGROUND OF THE INVENTION

Traditionally electronic circuits have been fabricated on circuit boards, known as printed circuit boards (PCBs), with circuitry formed on one or both sides thereof. To make such circuit boards, a copper coated insulating board made of a composite material is treated with a light-sensitive material, known as a photoresist, which is imaged with the pattern of the desired electronic circuit, typically by exposing the photoresist through a photomask formed by exposing and developing a high resolution monochrome photographic film according to the desired circuit pattern. The resist is affected by the exposure such that the exposed and non-exposed parts can be differentiated in terms of ease or method of removal. The imaged resist is then treated to remove the resist in an image-wise manner to reveal bare copper. The bared copper is then etched away and then the remaining resist removed to reveal a copper track on the insulating board. A second board may be made in a similar way with its own circuit pattern and the two boards bonded together and optionally connected by vias.

The process of making electronic circuit boards such as this can be quite laborious and involves several sequential steps, as well as complex equipment for effecting the exposure of the photomask and/or of the photoresist.

In view of the proliferation of electronic devices in almost every conceivable market and particularly in, for example, the fields of imaging, lighting and display and in view of the continuing demand for electronic products that are increasingly durable, thin, lightweight and of low cost, it is desirable to provide a method of forming conductive tracks which can be applied to a flexible substrate in a simple and efficient manner which can, if necessary, be useful in the mass production of electronic devices.

Some attempts have been made to provide for an alternative method of generating conductive tracks that allow for their formation on flexible substrates or avoiding the multiple step methodology associated with the traditional process of manufacturing PCBs.

GB-A-0585035 describes an improved method of making articles such as metal meshes by forming a stencil on a support as a photographic image of the article and using the stencil to deposit metal onto the support to form the article. A stencil may be formed, for example, by image-wise exposing a gelatino-silver halide emulsion layer and removing the exposed parts in which silver is formed, for example by washing in a hydrogen peroxide bath. Metal may then be chemically deposited onto the exposed portions of the support and the unexposed silver halide emulsion removed.

U.S. Pat. No. 5,384,230 describes a method of fabricating printed circuit boards whereby the surface of a circuit board is covered with a photoresist layer and the photoresist layer is in turn covered with a silver halide emulsion layer. The silver halide emulsion layer is then exposed according to a desired circuit board pattern with white light and the image developed to form a high definition mask in direct contact with the resist. The board is then exposed to UV light through the imaged emulsion layer, which is then stripped, and the exposed photoresist-coated board processed in the conventional manner.

U.S. Pat. No. 3,223,525 describes a method of manufacturing, by photographic means, external electrically conductive noble-metal patterns on non-conductive supports. In the described method, a non-conductive support is treated with a light-sensitive compound such as silver halide, exposed to light to produce a silver or mercury germ image, which is then treated with a stabilised physical developer for a prolonged period of time, whereby the internal image is made to grow out beyond the surface of the support to become an external image having resistivity of less than 10⁴ ohms per square.

U.S. Pat. No. 3,929,483 describes a method by which one-sided and/or two-sided plated through-conductive circuit boards useful for printed circuits may be produced. An anodized aluminium sheet sensitised (on one or both sides) with silver salts is exposed according to a circuit pattern and developed, optionally with a physical developer, to generate a silver image. This is treated with hypochlorite solution and the resulting bleached image plated with a metal to form conductive tracks. Where tracks are formed on both sides of the support, they may be connected by drilling through the support using standard techniques or by utilising a pre-drilled support.

U.S. Pat. No. 3,647,456 relates to a method of making electrically conductive silver images with the object of providing such silver images having high spatial resolution, which may be advantageously utilised in printed circuit techniques, thereby eliminating the need for an aluminium layer in photoresists and establishing a silver pattern directly upon a wafer. A coating of silver bromide emulsion comprising cadmium iodide is provided on a substrate to produce a latent image on the substrate, the latent image developed using a high resolution developer to provide a silver image and the silver image heated at a temperature of from 200° C. to 450° C. to render the silver image electrically conductive.

The use of pressure fogging of photosensitive materials is known, aside from causing problems of unwanted fog in, for example, U.S. Pat. No. 5,420,699, where pressure exposure of a photographic paper using a dot impact head to store information in the form of a barcode, for example, is described.

The various alternative methods of generating printed circuit patterns illustrated in some of the above-referenced documents each has advantages as described therein, but tends to require complex optical exposure techniques.

### PROBLEM TO BE SOLVED BY THE INVENTION

It is desirable to provide a method of forming conductive tracks which is more efficient and involves fewer steps in fabrication as compared, for example, with traditional printed circuit board manufacture.

It is further desirable to provide a method capable of forming conductive tracks or conductive areas having gaps with high resolution to meet the demands of increasingly complex circuitry of high-tech devices.

It is still further desirable to provide a method of forming conductive tracks on a flexible support that does not involve complex optical exposure techniques.

### SUMMARY OF THE INVENTION

According to a first aspect of the invention, there is provided a method of forming conductive tracks on a support, the method comprising the steps of providing a coated support, wherein the coating is susceptible to forming a latent image upon pressure exposure; pressure exposing said coated support according to a desired track pattern to form a latent image of the track pattern; and developing said latent image to form a conductive metal track pattern corresponding to the latent image.

In a second aspect of the invention, there is provided an electrical conductor comprising a conductive track on a support, obtainable by the above method.

In a third aspect of the invention, there is provided a coated support for use in the above method, said coated support comprising a support and a coating comprising a pressure-sensitive metal salt, wherein said coated support does not comprise one or more of a sensitising dye, a metal salt sensitive to electromagnetic radiation in the visible region of the spectrum, and an anti-halation dye.

In a fourth aspect of the invention, there is provided a coated support for use in a method described above, in which the step of developing the latent image comprises thermal development, said coated support comprising a pressure-sensitive silver halide, a secondary source of silver ions in catalytic proximity to the silver halide and an incorporated developer composition.

In a fifth aspect of the invention, there is provided a use of a coated support in the manufacture of conductive tracks on a support according to the above method, wherein said coated support comprises a pressure-sensitive metal salt in a carrier composition.

### ADVANTAGEOUS EFFECT OF THE INVENTION

The method of the invention enables the formation of conductive tracks on a support, such as a flexible, transparent support, in a simple and effective manner, without the need for complex optical processes or the precursors associated therewith. The method is capable of providing high resolution tracks by the application of pressure to, for example, a pressure-sensitive silver halide emulsion coated film, which has the advantage of simplicity of the film and of the exposure process as compared with an analogous photographic exposure method. The simple exposure method is also capable of providing conductive tracks at high speed making it suitable for use in high volume manufacture of simple electronic circuits.

### DETAILED DESCRIPTION OF THE INVENTION

The present invention is concerned with a method of forming conductive tracks on a support. A material having such conductive tracks on a support may find utility as the electronic circuitry in electronic devices where printed circuit boards are typically used, as backplanes in flexible displays and the like. The method comprises providing a coated support, wherein the coating is susceptible to forming a latent image upon pressure exposure (i.e. a pressure-sensitive element), applying pressure to the coated support according to a desired track pattern to effectively form a latent image of the track pattern, and developing the latent image to form a conductive metal track pattern corresponding to the latent image.

The coated support typically comprises a pressure-sensitive metal salt dispersed in a carrier composition. Any pressure sensitive-metal salt capable of providing a latent image upon application of pressure may be used provided that it is capable of being developed to provide a conductive track pattern, preferably without the need for a physical or electrochemical development step (i.e. forms a conductive track upon conventional or thermal development of the latent image). Suitable such pressure-sensitive metal salts include salts of copper, nickel, gold, platinum and silver. Metal salts with an oxidation state of +1 are preferred and particularly preferred are silver (I) salts, preferably a silver halide selected for example, from silver chloride, silver bromide, silver chlorobromide and silver chlorobromoiodide.

The carrier composition may be any suitable substantially non-conductive binder material for the purpose and is preferably a non-conductive hydrophilic binder.

Optionally, the coated support comprises a further polymer, either in the pressure-sensitive coating or as an overcoat, for improving the pliability of the coated support, especially to assist in the pressure exposure step. Suitable such polymers include vinyl polymer or copolymer. The vinyl polymer is preferably an acrylic polymer and preferably contains units derived from one or more alkyl or substituted alkyl acrylates or methacrylates, alkyl or substituted acrylamides, or acrylates or acrylamides containing a sulfonic acid group. Such further polymer should preferably be present in an amount to provide the benefit referred to, whilst maintaining a suitably high ratio of metal salt to total polymer.

The support can be any suitable support for making conductive elements and depending upon the application of the conductive element to be formed. The support may be transparent or opaque, rigid or flexible. Suitable supports include, for example, conventional printed circuit board substrate, glass, paper, resin coated paper, polyethylene terephthalate (PET), polyethylene naphthalate (PEN) and cellulose triacetate. In accordance with the present invention the coating may be applied to rigid, glass-reinforced epoxy laminates, semiconductor components, adhesive-coated polymer substrates, polymer-based PCBs, ceramic substrates, polymer tapes (e.g. dielectric green tape for multi-layer ceramic devices), paper, gloss art paper, bond paper, semi-synthetic paper (e.g. polyester fibre), synthetic paper (e.g. Polyart™), resin-coated paper, polymer substrates and composite materials. Suitable polymers for use as polymer substrates include polyethylene, polypropylene, polyester, polyamide, polyimide, polysulfone and mixtures thereof. The substrate, especially a polymer substrate, may be treated to improve adhesion of the coating, e.g. silver halide emulsion, to the substrate surface. For example, the substrate may be coated with a polymer adhesive layer or the surface may be chemically treated or subjected to a corona treatment. Preferred supports are flexible supports. An Estar® PET support or a cellulose triacetate support is preferable.

Alternatively, the support may be the same support used in a flexible display device, by which it is meant that the pressure-sensitive coating may be coated onto the back of a support for a display device and imaged in situ according to a desired pattern and processed in situ.

Where a discrete support is utilised (i.e. the support is not the reverse side of a support for a flexible display device), it can be coated with pressure-sensitive layers on both sides, provided that either the same pattern is desired for both sides or the support is sufficiently thick that formation of the latent image on one side of the support will not fog the coating on the other side of the support.

Development of the latent image, formed from the pressure exposure of the coated support, to form the conductive metal pattern corresponding to the desired pattern may comprise of one or more of conventional development, physical development and electrochemical development.

By conventional development, it is meant that the latent or germ image is treated with a developer composition, which may be incorporated in the coating, but requiring activation (e.g. by heating, i.e. thermal development, or changing pH), or may be added as a solution as part of a development process. The developer composition typically comprises a reducing agent capable of reducing the metal salt to the elemental metal, when catatysed by the elemental particles of the latent or germ image under the conditions of the development process.

By physical development or electroless plating, it is meant that the latent image (or the metal image formed by conventional development) is treated with a solution of a metal salt or complex of the same, or different, metal as that formed by conventional development of the latent image. Typically the physical development composition will further comprise a reducing agent to enable the physical development composition to be applied directly to the latent image.

By electrochemical development or electroplating, it is meant that a conductive metal image formed by conventional development and/or physical development has a voltage applied across it in the presence of a plating solution comprising a salt or complex of a plating metal, which may be the same or different from that of the metal image to be plated, whereby the conductive metal image is made more conductive. Suitable metals for use in electroplating include, for example, copper, lead, nickel, chromium, gold and silver, preferably copper or silver and most preferably silver.

In the method of the invention, the pressure-exposed pressure-sensitive element may be developed by applying a conventional development step and/or a physical development step and, optionally, an electrochemical development step. Where the development of the exposed photosensitive element comprises a conventional development step and an electrochemical development step (i.e. direct electroplating of a developed image), it is necessary that the image formed by conventional development is sufficiently conductive when a voltage is applied across it. In this case, it is preferable to use the electroplating technique described in our U.S. patent application Ser. No. 11/400,928 entitled, “Method of Forming Conductive Tracks”, which disclosure is incorporated herein by reference.

The electroplating step of the process is achieved by providing a plating solution in contact with the conventional/physical development-generated metal track pattern whilst applying a voltage across the said metal track pattern through the solution, by making the metal track pattern the negatively-charged electrode (referred to as the cathode in electrochemistry) in an electrochemical cell.

The plating solution utilised according to the process of the invention may be, for example, a solution of a silver thiosulfate complex, e.g. Na₃Ag(S₂O₃)₂, where silver is the plating metal, a solution of copper sulfate optionally with or without a polyethylene glycol PEG 200, where copper is the plating metal, nickel sulfate, i.e. NiSO₃, in the presence of boric acid where nickel is the plating metal, or zinc sulfate, ZnSO₄, where zinc is the plating metal. Preferably the plating solution has an equivalent concentration of the plating metal of from 0.01 to 2 molar, more preferably 0.03 to 0.5 molar and still more preferably 0.05 to 0.2 molar. Boric acid to control pH and/or PEG as a throwing agent may optionally be added to any of the plating solutions utilised.

The conductive patterns formed by the method of the invention preferably have a conductivity (expressed as resistivity) of 50 ohms/square or less, being achievable with the preferred silver halide emulsions and a conventional development step, more preferably 10 ohms/square or less, still more 1 ohms/square or less. By pressure exposing a pressure-sensitive coated support of the type used in the method of the invention to a desired pattern and processing the exposed layer with a conventional development step and a physical development step, a conductivity of 0.2 ohms/square is readily achievable. By further adopting a electrochemical development (electroplating) step, conductivity of about 10 milliohms/square is achievable.

As mentioned above, silver is preferably the plating metal and so a solution of a silver salt or complex is preferably used. The silver salt is preferably a silver thiosulfate complex, e.g. Na₃Ag(S₂O₃)₂, and can be formed by making a solution of silver chloride, sodium sulfite and ammonium thiosulfate. Preferably, the silver plating solution has an equivalent concentration of silver of from 0.01 to 2 molar, more preferably 0.03 to 0.5 molar and still more preferably 0.05 to 0.2 molar. The low equivalent concentration of silver in the plating solution enables the plating process to be controlled, allowing even plating across the patterned conductor and minimising the build-up of plating metal close to the electronic contacts.

The formulation of metal salts for use in the plating solution may be adapted from any suitable plating solution formulation, a useful source of known plating solution formulations including “Modern Electroplating” 4^{th} Edn, Ed. M. Schlesinger, M. Pacinovic, published by Wiley.

Preferably, the developed silver image has a surface conductivity of 40 ohms/square or less. The voltage applied across the patterned conductor is preferably up to 2 V, more preferably up to 1 V.

The latent image is formed upon the coated support by applying pressure thereto according to a pattern. The degree of pressure to be applied is commensurate with the pressure sensitivity of the coated support, could depend upon the precise nature of the coated support and would be readily appreciated by the skilled person in the art. The method of applying pressure to generate a latent image is any suitable method by which a desired image can be applied, using any suitable pressurising device. For example, the latent image may be formed by applying pressure using a stylus (especially a high resolution stylus) or scalpel, an engraved stamp engraved according to the desired track pattern or a roller carrying a relief pattern according to the desired track pattern, such that latent images can be formed rapidly on a sequence of coated supports, especially flexible coated supports. Where the desired track pattern is a random conductive track pattern, the latent image may be formed by any suitable means of generating a random pattern, such as by rubbing the surface of the coated support with steel wool or (plastic) scouring pad or equivalent.

The resolution of the conductive tracks formed depends primarily on the resolution of the pressurising device. However, the step of pressure exposing the pressure-sensitive coated support enables fine control of the resolution of the tracks to be formed and furthermore enables very fine lines to be generated. For many applications it is preferred to form high resolution conductive tracks. Preferably, therefore, the conductive tracks formed have a line width of 50 μm or less, more preferably 20 μm or less, still more preferably 10 μm or less and most preferably 5 μm or less. Advantageously, for some applications, line widths of 1 or 2 μm may be formed and preferably for ease of use the line widths are at least 0.1 μm, preferably 0.5 μm wide.

As mentioned above, the coating of the coated support may comprise a pressure-sensitive metal salt, which is preferably a silver halide, in a carrier composition. Due to the relatively simple exposure method of applying pressure to the coated support according to the desired pattern, the pressure-sensitive coating may be a much simpler formulation than would typically be required for a corresponding more complex photosensitive coating. Several components that would typically be included in a photosensitive silver halide coated support to enable effective actinic radiation exposure are not required for the pressure-exposure method of the present invention. For example, a pressure-sensitive metal salt in a typical coated support useful in the present invention does not need to have been sensitised to a particular wavelength of light and so does not need to have a sensitising dye present. Similarly, there is no requirement that an anti-halation dye, which minimises unwanted radiation exposure, be present. Indeed, there is no requirement that there be present any dye whatsoever and so the coated support utilised may, optionally, have no dyes or dye-forming components present. Therefore, to simplify the formulation of the coated support, it is preferred that one or more, or preferably all, of such components are not present.

According to a preferred embodiment of the invention, the coated support comprises a silver halide dispersed in a hydrophilic colloid binder. The hydrophilic colloid may be gelatin or a gelatin derivative, polyvinylpyrrolidone or casein and may contain a polymer. Suitable hydrophilic colloids and vinyl polymers and copolymers are described in Section IX of the Research Disclosure referred to below. The preferred hydrophilic colloid is gelatin.

The silver halide may be, for example, silver chloride, silver bromide, silver chlorobromide or silver bromoiodide. Preferably, the silver halide emulsion is a high contrast silver halide emulsion which is suitable for use in the graphic arts and in manufacturing printed circuit boards, for example, to which the present invention is particularly applicable. The silver halide emulsion is preferably a chlorobromide emulsion, preferably comprising at least 50 mol % silver chloride, more preferably 60-90 mol % silver chloride and most preferably 60-80 mol % silver chloride. The remainder of the silver halide is preferably substantially made up of silver bromide and more preferably comprises a small proportion (e.g. up to 1 or 2%) of silver iodide.

Preferably, the pressure-sensitive material is a high silver/low gelatin material, so that after conventional development it is sufficiently conductive to enable direct electroplating of the metal pattern formed. In this regard, a preferred ratio of gelatin to silver in the pressure sensitive coating is in the range of from 0.1 to 0.7, more preferably from 0.2 to 0.6.

The silver halide grains are preferably of a size ranging from about 10 nm to about 10,000 nm in at least one dimension. The emulsion grains may be cubic, octahedral, rounded octahedral, polymorphic, tabular or thin tabular emulsion grains, preferably cubic, octahedral or tabular grains. Such silver halide grains may be regular untwinned, regular twinned, or irregular twinned with cubic or octahedral faces. The silver halide grains may also be composed of mixed halides.

When the emulsion composition is a mixed halide, the minor component may be added in the crystal formation or after formation as part of the sensitisation or melting. The emulsions may be precipitated in any suitable environment such as a ripening environment, a reducing environment or an oxidising environment.

Specific references relating to the preparation of emulsions of differing halide ratios and morphologies are Evans U.S. Pat. No. 3,618,622, Atwell U.S. Pat. No. 4,269,927, Wey U.S. Pat. No. 4,414,306, Maskasky, U.S. Pat. No. 4,400,463, Maskasky U.S. Pat. No. 4,713,323, Tufano et al, U.S. Pat. No. 4,804,621, Takada et al U.S. Pat. No. 4,738,398, Nishikawa et al U.S. Pat. No. 4,952,491, Ishiguro et al U.S. Pat. No. 4,493,508, Hasebe et al U.S. Pat. No. 4,820,624, Maskasky U.S. Pat. Nos. 5,264,337 and 5,275,930, House et al U.S. Pat. No. 5,320,938 and Chen et al U.S. Pat. No. 5,550,013, Edwards et al U.S. Ser. No. 08/362,283 filed on Dec. 22, 1994 and U.S. Pat. Nos. 5,726,005 and 5,736,310.

In one embodiment, the coating of the coated support comprises pressure-sensitive tabular silver halide grains in a carrier composition, such as gelatin. Optionally, no further additives are included in any substantive amounts leading to an extremely simple formulation of a pressure-sensitive element.

The emulsions employed in the pressure-sensitive materials described herein, and the addenda added thereto, the binders, supports, etc., may be as described for certain photographic materials in Research Disclosure Item 36544, September 1994, published by Kenneth Mason Publications, Emsworth Hants, PO10 7DQ, UK.

The silver halide emulsion may be coated onto any suitable support, which is preferably a transparent support, such as an Estar® PET support.

The coated support may also contain an overcoat hydrophilic colloid layer, which may also contain a vinyl polymer or copolymer located as the last layer of the coating (furthest from the support). It may contain one or more surfactants to aid coatability and may also contain some form of matting agent. The vinyl polymer is preferably an acrylic polymer and preferably contains units derived from one or more alkyl or substituted alkyl acrylates or methacrylates, alkyl or substituted acrylamides, or acrylates or acrylamides containing a sulfonic acid group. Preferably, however, only a very thin overcoat or no overcoat at all is applied, in order to maximize the pressure-sensitivity of the coated support.

The silver halide emulsions may be prepared by any common method of grain growth, preferably using a balanced double run of silver nitrate and salt solutions using a feedback system designed to maintain the silver ion concentration in the growth reactor. Dopants may be introduced uniformly from start to finish of precipitation, or may be structured into regions or bands within the silver halide grains. Dopants, for example osmium dopants, ruthenium dopants, iron dopants, rhenium dopants or iridium dopants, for example cyanoruthenate dopants, may be added. Preferably a combination of osmium and iridium dopants is used and preferably the osmium dopant is an osmium nitrosyl pentachloride. Such complexes may alternatively be utilised as grain surface modifiers in the manner described in U.S. Pat. No. 5,385,817. Chemical sensitisation may be carried out by any of the known methods, for example with thiosulfate or other labile sulfur compound, and with gold complexes. Preferably, the chemical sensitisation is carried out with thiosulfate and gold complexes.

Antifoggants and stabilisers may be added as is known in the photographic art. Antifoggants that may be useful to prevent unwanted fogging and to help control the balance of pressure-sensitivity include, for example, azaindenes, such as tetraazaindenes, tetrazoles, benzotriazoles, imidazoles and benzimidazoles. Specific antifoggants that may be used include 5-carboxy-2-methylthio-4-hydroxy-6-methyl-1,3,3a,7-tetraazaindene, 1-(3-acetamidophenyl)-5-mercaptotetrazole, 6-nitrobenzimidazole, 2-methylbenzimidazole and benzotriazole.

Nucleators and, preferably, development boosters may be used to give ultra-high contrast, for example combinations of hydrazine nucleators such as those disclosed in U.S. Pat. No. 6,573,021, or those hydrazine nucleators disclosed in U.S. Pat. No. 5,512,415 col. 4, line 42 to col. 7, line 26, the disclosures of which are incorporated herein by reference. Booster compounds that may be present in the photographic material (or alternatively, in the developer solution used) include amine boosters that comprise at least one secondary or tertiary amino group and have an n-octanol/water partition coefficient (log P) of at least 1, preferably at least 3. Suitable amine boosters include those described in U.S. Pat. No. 5,512,415, col. 7, line 27 to col. 8, line 16, the disclosure of which is incorporated herein by reference. Preferred boosters are bis-tertiary amines and bis-secondary amines, preferably comprising dipropylamino groups linked by a chain of hydroxypropyl units, such as those described in U.S. Pat. No. 6,573,021. Any nucleator or booster compound utilised may be incorporated into the silver halide emulsion, or alternatively may be present in a hydrophilic colloid layer, preferably adjacent the layer containing the silver halide emulsion for which the effects of the nucleator are intended. They may, however, be distributed between or among emulsion and hydrophilic colloid layers, such as undercoat layer, interlayers and overcoat layers.

As a specific example, a silver halide material such as that described in U.S. Pat. No. 5,589,318 or U.S. Pat. No. 5,512,415 may be utilised.

The silver halide contained in the coated support may be processed following pressure exposure in order to form a visible image by associating the silver halide with an aqueous alkaline medium in the presence of a developing agent contained in the medium or in the coated support itself. The pressure-exposed coated support may be processed in conventional developers to obtain very high contrast images. When the coated support contains an incorporated developing agent, it can be processed in the presence of an activator, which may be identical to the developer in composition, but lacking a developing agent.

The developers are typically aqueous solutions although organic solvents, such as diethylene glycol, can also be included to facilitate the solution of organic components. The developers contain one or a combination of conventional developing agents, such as for example, a polyhydroxybenzene, such as dihydroxybenzene, aminophenol, a paraphenylenediamine, ascorbic acid, erythorbic acid and derivatives thereof, pyrazolidone, pyrazolone, pyrimidine, dithionite and hydroxylamine.

It is preferred to employ hydroquinone and 3-pyrazolidone developing agents in combination or an ascorbic acid-based system. An auxiliary developing agent exhibiting super-additive properties may also be used. The pH of the developers can be adjusted with alkali metal hydroxides and carbonates, borax and other basic salts. It is a particular advantage that the use of nucleators as described herein reduces the sensitivity of the material to changes in this developer pH.

To reduce gelatin swelling during development, compounds such as sodium sulfate can be incorporated into the developer. Chelating and sequestering agents, such as ethylenediamine tetraacetic acid or its sodium salt, can be present. Generally any conventional developer can be used in the practice of this invention. Specific illustrative developers are disclosed in the Handbook of Chemistry and Physics, 36^{th} Edition, under the title “Photographic Formulae” at page 30001 et seq. and in “processing Chemicals and Formulas”, 6^{th} Edition, published by Eastman Kodak Company (1963).

According to an alternative embodiment where the pressure-exposed coated support is heat developed to generate tracks according to the desired track pattern, the pressure-sensitive coating comprises a pressure-sensitive silver halide material and a secondary source of reducible silver ions.

Preferably, according to this embodiment of the invention, the silver halide material comprises that described generally above or more particularly one or more silver halides (often referred to as photocatalysts in the PTG imaging arts) such as silver bromide, silver iodide, silver chloride, silver bromoiodide, silver chlorobromoiodide, silver chlorobromide and others readily apparent to one skilled in the art. Silver bromide and silver bromoiodide are more preferred, the latter silver halide including up to 10 mol % silver iodide.

The silver halide grains preferably utilised in this embodiment may have a uniform ratio of halide throughout, may have a graded halide content with a continuously varying ratio of, for example, silver bromide and silver iodide, or they may be of the core-shell type having a core of one halide ratio and a shell of another halide ratio. Core-shell silver halide grains useful in photothermographic materials and methods of preparing these materials are described, for example in U.S. Pat. No. 5,382,504, which disclosure is incorporated herein by reference, as are the relevant disclosures of U.S. Pat. No. 5,434,043, U.S. Pat. No. 5,939,249 and EP-A-0627660, which describe iridium and/or copper doped core-shell and non-core shell grains.

The secondary source of reducible silver ions may be any silver ion source suitable for use in photothermographic imaging and is preferably a silver salt that is stable to light and forms a silver image when heated to 50° C. or higher in the presence of an exposed pressure-sensitive silver halide and a developer composition. The secondary silver ion source may be, for example, one or more of silver benzotriazoles, silver oxalates, silver acetylates and silver carboxylates, such as silver behenates, or any silver ion source selected from those described in EP-A-1191394, page 23 line 17 to page 24, line 14, the disclosure of which is incorporated herein by reference. Preferably, the secondary silver ion source is a silver benzotriazole, suitable such benzotriazoles being disclosed in U.S. Pat. No. 3,832,186, the disclosure of which is incorporated herein by reference, or a silver soap, such a silver behenate, having a formula [Ag(CO₂CₓH₂ₓ₋₁)]₂, preferably wherein x=18-22.

In this embodiment in which the latent image is developed through a heat development step, the secondary silver ion source and the silver halide material must be in catalytic proximity (i.e. in reactive association).

The dispersion (or emulsion, as it is often referred in the photographic arts) of the silver halide material and secondary silver ion source may be prepared by any suitable method for use in photothermographic imaging. It is preferred that an ex situ method is used, whereby the photosensitive silver halide grains are preformed then added to and physically mixed with the silver ion source. Alternatively, the silver ion source is formed in the presence of ex situ prepared silver halide such as by co-precipitation of the silver ion source in the presence of silver halide to provide a more intimate mixture. The preformed silver halide emulsions or dispersions utilised in this method may be prepared by aqueous or organic processes and can be unwashed or washed to remove soluble salts. Alternatively, an in situ process in which a halide-containing compound is added to an organic silver salt to partially convert the silver of the organic silver salt to silver halide may be effective. The halogen-containing compound may be inorganic, such as zinc bromide or lithium bromide or organic, such as N-bromosuccinimide. Additional methods of preparing the silver halide and organic silver salts and manners of blending them are described, for example in Research Disclosure, June 1978, Item No. 17029, U.S. Pat. No. 3,700,458 and U.S. Pat. No. 4,076,539.

The pressure-sensitive silver halide material used according to this embodiment may be chemically sensitised by any suitable method known in the photothermographic art.

The developer composition, which may be incorporated into the coated support, may be any suitable developer for reducing the source of silver ions to metallic silver in photothermographic imaging systems. Suitable such developers include those described in EP-A-1191394 at page 24, line 18 to page 24, line 51, which disclosure is incorporated herein by reference. Particularly preferred developer compositions are the bisphenol class of photothermographic developers.

A development activator, also known as an alkali-release agent, base-release agent or an activator precursor, may be useful in the development of latent images according to the present embodiment. A development activator is an agent or compound which aids the developing agent at processing temperatures to develop a latent image in the imaging material. Useful development activators or activator precursors are described, for example, in Belgian Patent. No. 709, 967 published Feb. 29, 1968, and Research Disclosure, Volume 155, March 1977, Item 15567. Examples of useful activator precursors include guanidinium compounds such as guanidinium trichloroacetate, diguanidinium glutarate, succinate, malonate and the like; quaternary ammonium malonates; amino acids, such as 6-aminocaproic acid and glycine; and 2-carboxycarboxamide activator precursors.

Other addenda that may be incorporated into the coated support to be used in the photothermographic system according to this embodiment include, for example, stabilisers, toners, anti-foggants, contrast-enhancers, development-accelerators, post-processing stabilisers or stabiliser precursors and other image-modifying agents, as would be readily apparent to the person skilled in the art. Heat transfer agents may also be incorporated.

As mentioned above, the conductive tracks formed according to the method of the invention may form the electronic circuitry for various electronic devices. This may be in the form of a single layer of conductive tracks or multiple layers. Where more than two layers of circuitry are used, it is typically desirable to form electrical connections between the conductive patterns on each support or on each side of a support coated on both sides. One conductive pattern formed may be connected as desired to another conductive pattern formed by drilling holes or vias through the conductive element(s) and filling or coating the vias with a conductive material.

The invention will now be described in detail, without limitation, by reference to the following Examples.

### EXAMPLES

### Example 1

A sample of Kodak Polychrome Graphics GRD film (a red-sensitive, high contrast graphics film used as a film intermediate in plate manufacture) was pressure-exposed using a scalpel as a stylus and then processed using a standard graphics art processor (Glunz & Jenson Multiline 55 Mk II photographic processor, Kodak Polychrome Graphics HX 1735 Developer 1+2, 30 s @ 35° C., RA3000 fix 1+3 30 s @ 33° C., wash and dry 55° C.).

The line formed was 20.4 μm wide and had a sheet resistivity of 190 ohms/square.

### Example 2

A coating consisting of 100 μm thick substrate of PET coated with an emulsion layer of 0.18 μm chemically sensitized silver chlorobromide (30% bromide) cubes at a silver laydown of 3.6 g/m² and a gel laydown of 1.6 g/m² was overcoated with a layer of gelatin plus surfactant to give 0.3 g/m² of gelatin in this layer. No hardener was added to the coating.

A random array of tracks was formed on this sample by pressure-fogging the sample by rubbing with a 3M Scotchbrite® Pad. This sample was then processed in the following way to produce a relatively transparent conductive film made up of numerous very fine, conductive tracks.

| | | |
|---|---|---|
| Developer | 30 s | at 21° C. with nitrogen burst agitation |
| Fixer | 45 s | at 21° C. with continuous air agitation |
| Wash in running water | 60 s | at 15-20° C. with continuous air agitation |
| Dry at room | | |
| temperature | | |

Using the following formulae:

### Developer

| | | |
|---|---|---|
| Sodium metabisulfite | 24 | g |
| Sodium bromide | 4 | g |
| Benzotriazole | 0.2 | g |
| 1-Phenyl-5-mercaptotetrazole | 0.013 | g |
| Hydroquinone (photograde) | 25.0 | g |
| 4-Hydroxymethyl-4-methyl-1-phenyl-3-pyrazolidone | 0.8 | g |
| Potassium sulfite | 35 | g |
| Potassium carbonate | 20 | g |
| Water to | 1 | litre |
| pH adjusted to 10.4 with 50% potassium hydroxide | | |

### Fixer

| | | |
|---|---|---|
| Ammonium thiosulfate | 200 | g |
| Sodium sulfite | 20 | g |
| Acetic acid | 10 | ml |
| Water to | 1 | litre |

The overall sheet resistivity of this sample was measured and found to be 5 K ohms/square and the strip had a transmission density of 0.07 DU. The conductive line thicknesses varied between 1.9 μm and 10 μm.

### Example 3

Example 2 was repeated but singles lines were formed by using a scalpel as a stylus to pressure-expose the coating.

The lines formed were 5.5 μm thick and had a sheet resistivity of 30 ohms/square.

1. A method of forming conductive tracks on a support, the method comprising the steps of
providing a coated support, wherein the coating is susceptible to forming a latent image upon pressure exposure;
pressure-exposing said coated support according to a desired track pattern to form a latent image of the track pattern; and
developing said latent image to form a conductive metal track pattern corresponding to the latent image.

2. A method as claimed in claim 1, wherein said coated support comprises a pressure-sensitive metal salt dispersed in a carrier composition.

3. A method as claimed in claim 2, wherein said pressure-sensitive metal salt is a silver salt.

4. A method as claimed in claim 3, wherein said silver salt is one or more of silver chloride, silver bromide, silver chlorobromide and silver chlorobromoiodide.

5. A method as claimed in claim 2, wherein said carrier composition comprises gelatin.

6. A method as claimed in claim 1, wherein the step of developing said latent image to form said conductive metal track pattern comprises one or more of conventional development, thermal development, physical development and electrochemical development.

7. A method as claimed in claim 6, wherein the step of developing comprises thermal development wherein said coated support comprises a pressure-sensitive silver halide, a secondary source of silver ions in catalytic proximity to said silver halide and an incorporated developer composition, whereby upon pressure-exposure and heating said conductive metal track is formed according to a said desired track pattern.

8. A method as claimed in claim 1 wherein the step of pressure-exposing said coated support according to said desired track pattern comprises application of a high resolution stylus, an engraved stamp or a roller carrying a relief pattern according to said desired track pattern.

9. A method as claimed in claim 1, wherein said conductive tracks have a line width of 50 μm or less.

10. A method as claimed in claim 9, wherein said conductive tracks have a line width of 5 μm or less.

11. A method as claimed in claim 1, wherein said coated support is a flexible, transparent coated support.

12. An electrical conductor comprising a conductive track on a support, obtainable by the method of claim 1.

13. A coated support for use in the method of claim 1, said coated support comprising a support and a coating comprising a pressure-sensitive metal salt, wherein said coated support does not comprise any one of a sensitising dye, a pressure-sensitive metal salt sensitive to electromagnetic radiation in the visible region of the spectrum or an anti-halation dye or any combination thereof.

14. A coated support for use in the method of claim 7, said coated support comprising a pressure-sensitive silver halide, a secondary source of silver ions in catalytic proximity to said silver halide and an incorporated developer composition.

15. (canceled)

16. (canceled)
